(19) United States
(12) Patent Application Publication
(10) Pub. No.: US 2025/0201934 A1
(43) Pub. Date: Jun. 19, 2025

(54) Power Storage Device

(71) Applicant: TOYOTA JIDOSHA KABUSHIKI KAISHA, Toyota-shi Aichi-ken (JP)

(72) Inventors: Kazuhito KATO, Toyota-shi Aichi-ken (JP); Junta TAKASU, Nagoya-shi Aichi-ken (JP); Atsushi YAMANAKA, Nagoya-shi Aichi-ken (JP); Masato ONO, Nagoya-shi Aichi-ken (JP); Satoshi MORIYAMA, Nagoya-shi Aichi-ken (JP); Kosuke SUZUKI, Toyota-shi Aichi-ken (JP); Kazuki SUGIE, Miyoshi-shi Aichi-ken (JP); Kazuya KUMAZAWA, Nagoya-shi Aichi-ken (JP)

(73) Assignee: TOYOTA JIDOSHA KABUSHIKI KAISHA, Toyota-shi Aichi-ken (JP)

(21) Appl. No.: 18/976,792

(22) Filed: Dec. 11, 2024

(30) Foreign Application Priority Data
Dec. 15, 2023 (JP) 2023-212085

(51) Int. Cl. H01M 10/0587; H01M 4/02; H01M 4/131; H01M 10/42; H01M 50/107; H01M 50/152; H01M 50/645

(52) U.S. Cl. CPC H01M 10/0587; H01M 4/131; H01M 10/4214; H01M 50/107; H01M 50/152; H01M 50/645; H01M 2004/027; H01M 2004/028; H01M 2220/20

(57) ABSTRACT

A power storage device includes: a wound electrode assembly with a winding axis extending in a predetermined direction, the wound electrode assembly being formed of a stack wound spirally around the winding axis, the stack including a positive electrode in a strip shape, a negative electrode in a strip shape, and a separator in a strip shape; and a case containing an electrolyte solution and the wound electrode assembly. The wound electrode assembly has an outer peripheral surface facing the case. A first hole extending in a direction from the outer peripheral surface toward the winding axis is formed in the wound electrode assembly.

### CROSS REFERENCE TO RELATED APPLICATIONS

This nonprovisional application is based on Japanese Patent Application No. 2023-212085 filed on Dec. 15, 2023 with the Japan Patent Office the entire contents of which are hereby incorporated by reference.

### BACKGROUND

### Field

The present disclosure relates to a power storage device.

### Description of the Background Art

Conventionally, as disclosed in Japanese Patent Laying-Open No. 4-184871, there is known a battery including a wound electrode assembly in a battery can, the wound electrode assembly being configured by stacking a strip-shaped negative electrode and a strip-shaped positive electrode with a strip-shaped separator interposed therebetween and then spirally winding the stack.

### SUMMARY

As the size of the wound electrode assembly as illustrated in Japanese Patent Laying-Open No. 4-184871 is increased, an electrolyte solution sealed in the case (battery can) hardly penetrates into the wound electrode assembly.

The present disclosure provides a power storage device in which an electrolyte solution is easily permeated into a wound electrode assembly contained in a case.

According to an aspect of the present disclosure, a power storage device includes: a wound electrode assembly with a winding axis extending in a predetermined direction, the wound electrode assembly being formed of a stack wound spirally around the winding axis, the stack including a positive electrode in a strip shape, a negative electrode in a strip shape, and a separator in a strip shape; and a case containing an electrolyte solution and the wound electrode assembly. The wound electrode assembly has an outer peripheral surface facing the case. A first hole extending in a direction from the outer peripheral surface toward the winding axis is formed in the wound electrode assembly.

With the above-described configuration, it is possible to allow the electrolyte solution to permeate into the wound electrode assembly from the outer peripheral surface side of the wound electrode assembly through the first hole. As such, in the power storage device, the electrolyte solution is more easily permeated into the wound electrode assembly, as compared with a configuration without the first hole in the wound electrode assembly,

In some embodiments, the first hole includes a plurality of positive electrode through holes formed in the positive electrode, a plurality of negative electrode through holes formed in the negative electrode, and a plurality of separator through holes formed in the separator. An opening area of each of the separator through holes is smaller than an opening area of each of the negative electrode through holes and an opening area of each of the positive electrode through holes.

With the above-described configuration, it is possible to reduce the possibility of short circuit between the negative electrode and the positive electrode through the separator through hole, as compared with the case where the opening area of each separator through hole is larger than the opening area of each negative electrode through hole and the opening area of each positive electrode through hole.

In some embodiments, the opening area of each of the positive electrode through holes is larger than the opening area of each of the negative electrode through holes.

With the above-described configuration, it is possible to further reduce the possibility of short circuit between the negative electrode and the positive electrode through the separator through hole.

In some embodiments, the case has an inner peripheral surface facing the outer peripheral surface. A groove extending in the predetermined direction is formed in the inner peripheral surface. The groove faces the first hole.

With the above-described configuration, it is possible to allow the electrolyte solution and gas to be exchanged between the groove and the first hole. As such, the power storage device is desirable in terms of injection of the electrolyte solution and discharge of gas generated from the wound electrode assembly, as compared with a configuration having no groove.

In some embodiments, the case includes: a main body having an upper end portion, with the groove extending to the upper end portion; and a lid having a second hole formed to extend through the lid in the predetermined direction, the lid being attached to the main body from above. The second hole is located above the groove. The power storage device further includes a closing member that closes the second hole.

With the above-described configuration in which the second hole is located above the groove, it is possible to easily guide the electrolyte solution into the groove by injecting the electrolyte solution from the second hole.

The foregoing and other objects, features, aspects, and advantages of the present disclosure will become more apparent from the following detailed description of the present disclosure when taken in conjunction with the accompanying drawings.

### BRIEF DESCRIPTION OF THE DRAWINGS

FIG. 1 is an exploded view for explaining a configuration of a power storage device.

FIG. 2 is a cross-sectional view taken along line II-II of FIG. 1.

FIG. 3 is a perspective view of the wound electrode assembly.

FIG. 4 is a diagram for explaining elements constituting a hole of the wound electrode assembly.

### DESCRIPTION OF THE EMBODIMENTS

Hereinafter, embodiments of the present disclosure will be described with reference to the drawings. In the following description, the same members are denoted by the same reference numerals. Their names and functions are also the same. Therefore, detailed description thereof will not be repeated.

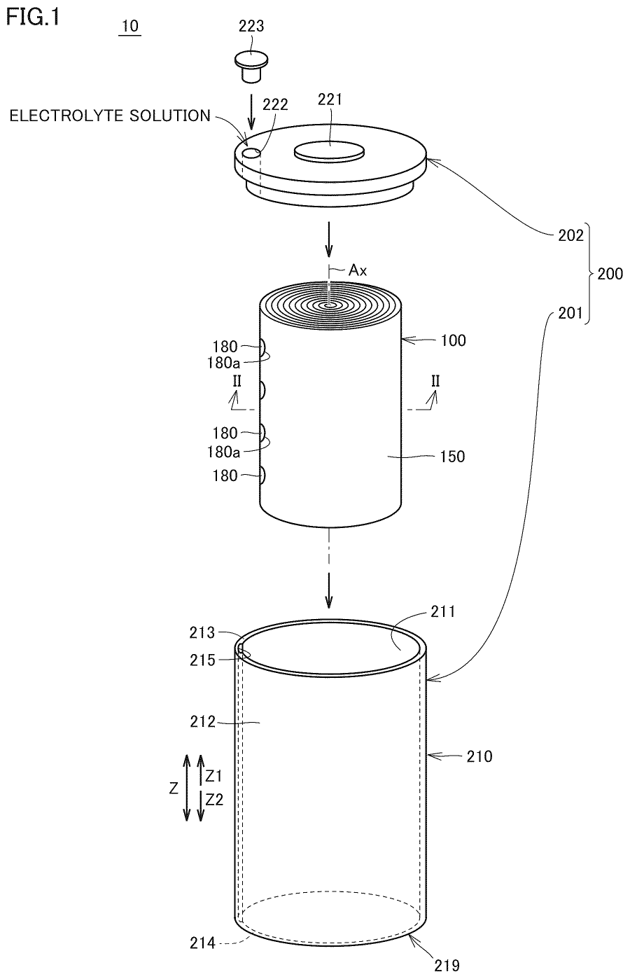

FIG. 1 is an exploded view for explaining a configuration of a power storage device 10 according to the present embodiment. As shown in FIG. 1, the power storage device 10 includes a wound electrode assembly 100 and a case 200. The power storage device 10 is mounted on an electrically powered vehicle such as a hybrid electric vehicle that can travel using power of at least one of a motor and an engine, or an electric vehicle that travels using a driving force obtained by electric energy.

The wound electrode assembly 100 has an outer peripheral surface 150 facing the case 200. A plurality of holes 180 are formed in the wound electrode assembly 100. In this example, in the wound electrode assembly 100, four holes 180 are formed in a row in the vertical direction (Z direction). In the outer peripheral surface 150, opening ends 180a of the holes 180 are aligned in the Z direction.

The case 200 contains the wound electrode assembly 100 and an electrolyte solution. The case 200 includes a main body 201 and a lid 202. The main body 201 has a trunk portion 210 and a bottom portion 219. The case 200 is also referred to as “cell case”.

In this example, the bottom portion 219 is circular in a top view of the main body 201. The trunk portion 210 extends in a direction from the bottom portion 219 toward the lid 202 (in the Z1 direction of the Z direction in the drawing). The trunk portion 210 has a cylindrical shape.

The trunk portion 210 has an inner peripheral surface 211, an outer peripheral surface 212, an upper end portion 213, and a lower end portion 214. The inner peripheral surface 211 faces the wound electrode assembly 100. The inner peripheral surface 211 faces the outer peripheral surface 150 of the wound electrode assembly 100. The upper end portion 213 is in contact with the lid 202. The lower end portion 214 is contiguous to the bottom portion 219.

A groove 215 extending in the vertical direction (Z direction in the drawing) is formed in the inner peripheral surface 211. The groove 215 extends from the lower end portion 214 to the upper end portion 213. The groove 215 faces each hole 180 formed in the wound electrode assembly 100. Specifically, the groove 215 faces the opening end 180a of each hole 180. More specifically, position of the wound electrode assembly 100 is fixed in the case 200 so that the opening end 180a faces the groove 215. Since the groove 215 is formed in a part of the inner peripheral surface 211 of the case 200, the opening end 180a is not closed by the inner peripheral surface 211 of the case 200.

The lid 202 has an external terminal 221 connected to the wound electrode assembly 100. The lid 202 is formed with a through hole 222 for injecting the electrolyte solution into the case 200 (specifically, the main body 201). The through hole 222 functions as a liquid injection port. The through hole 222 extends in the Z direction. The through hole 222 is located above the groove 215. Accordingly, the electrolyte solution to be injected into the main body 201 through the through hole 222 can be reliably guided to the groove 215. Specifically, the electrolyte solution can be dropped downward (in the direction of Z2) along the groove 215 and the periphery of the groove 215 in the inner peripheral surface 211.

The lid 202 further has a cap 223 for closing the through hole 222. The lid 202 is attached to the main body 201 from above. The cap 223 can prevent the electrolyte solution from leaking from the case 200.

The power storage device 10 is manufactured by the following steps. The wound electrode assembly 100 is housed in the main body 201 of the case 200. Thereafter, the lid 202 is placed over the main body 201. Further, the lid 202 is fixed to the main body 201. Next, an electrolyte solution is injected into the case 200 through the through hole 222. After the electrolyte solution is injected, the through hole 222 is sealed with the cap 223.

The Z direction is an example of the “predetermined direction” in the present disclosure. The direction of R1 in the R direction is an example of the “direction from the outer peripheral surface toward the winding axis” in the present disclosure. The hole 180 is an example of the “first hole” in the present disclosure. The through hole 222 is an example of the “second hole” in the present disclosure. The cap 223 is an example of the “closing member” of the present disclosure.

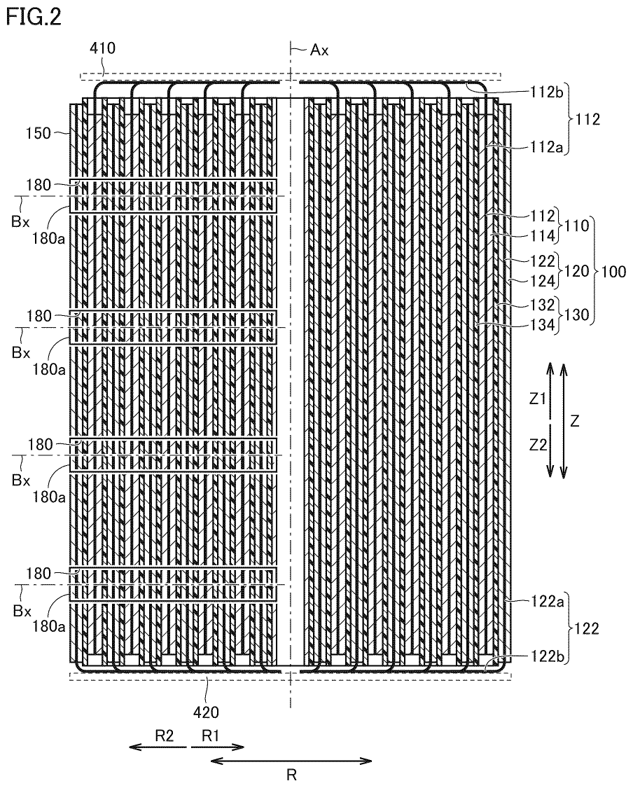

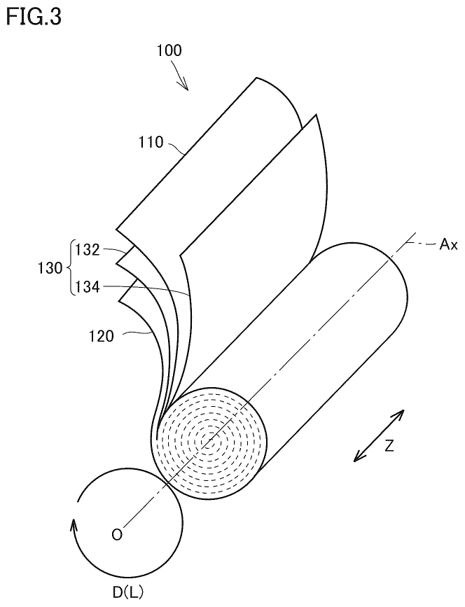

Next, the wound electrode assembly 100 will be described in detail with reference to FIGS. 2 to 4. FIG. 2 is a cross-sectional view taken along line II-II of FIG. 1. FIG. 3 is a perspective view of the wound electrode assembly 100.

As shown in FIGS. 2 and 3, the wound electrode assembly 100 has a winding axis Ax extending in the Z direction. The wound electrode assembly 100 is configured by spirally winding a stack including a strip-shaped positive electrode 110, a strip-shaped negative electrode 120, and a strip-shaped separator 130 around the winding axis Ax.

Specifically, the separator 130 includes a first separator 132 and a second separator 134. In the stack, the negative electrode 120, the first separator 132, the positive electrode 110, and the second separator 134 are stacked in this order. The stack is wound in the direction of arrow D in FIG. 3 (longitudinal direction L of the stack).

As shown in FIG. 2, the positive electrode 110 includes a positive electrode current collector foil 112 and a positive electrode active material layer 114. The positive electrode current collector foil 112 may contain, for example, Al or the like. The positive electrode current collector foil 112 includes a first region 112a and a second region 112b. The positive electrode active material layer 114 is disposed in the first region 112a. The positive electrode active material layer 114 may contain, for example, a lithium-nickel composite oxide or the like.

The second region 112b is adjacent to the first region 112a. The second region 112b is disposed at an end portion in the winding axis Ax direction. The second region 112b has a plurality of tabs. The plurality of tabs are separated in the winding direction (direction D in FIG. 3) of the wound electrode assembly 100. For example, a plurality of tabs may be welded to the second region 112b. For example, a part of the second region 112b may be processed into a tab. Each tab is bent inward in the radial direction. The “radial direction” is the R direction. The outer surface of each tab forms a generally flat surface. Each tab is connected to a positive electrode current collector plate 410. Each tab may be welded to the positive electrode current collector plate 410.

The negative electrode 120 includes a negative electrode current collector foil 122 and a negative electrode active material layer 124. The negative electrode current collector foil 122 may contain Cu, Ni, or the like, for example. The negative electrode current collector foil 122 includes a first region 122a and a second region 122b. The negative electrode active material layer 124 is disposed in the first region 122a. The negative electrode active material layer 124 may contain, for example, graphite, Si, SiO, or the like.

The second region 122b is adjacent to the first region 122a. The second region 122b is disposed at an end portion in the winding axis Ax direction. The second region 122b has a plurality of tabs. The plurality of tabs are separated in the winding direction of the wound electrode assembly 100. Each tab is bent inward in the radial direction. The outer surface of each tab forms a generally flat surface. Each tab is connected to a negative electrode current collector plate 420. Each tab may be welded to the negative electrode current collector plate 420. Each tab may be welded to bottom portion 219 of the case 200.

The separator 130 has the electrical insulation property. Separator 130 electrically separates the positive electrode 110 from the negative electrode 120. In the radial direction, the separator 130 is disposed between the positive electrode 110 and the negative electrode 120. The separator 130 is porous. The electrolyte solution may permeate the separator 130. The separator 130 may include, for example, a porous resin film or the like.

The outermost layer of the wound electrode assembly 100 may be an electrode or the separator 130. The “outermost layer” refers to a member located on the outermost side in the radial direction at the winding end portion of the wound electrode assembly 100, among the positive electrode 110, the negative electrode 120, and the separator 130. In the present embodiment, the outermost layer of the wound electrode assembly 100 is a negative electrode as shown in FIG. 3. That is, the outermost layer of the wound electrode assembly 100 is the negative electrode 120. More specifically, the outermost layer is the negative electrode active material layer 124, but may be the negative electrode current collector foil 122. The outermost layer is not limited to the negative electrode 120 and may be the positive electrode 110.

The outermost layer is in contact with the case 200. Specifically, the outermost layer is in close contact with the inner peripheral surface 211 of the main body 201. The portion of the case 200 that contacts the outermost layer (i.e., the inner peripheral surface 211) is made of an electrically conductive material.

The electrolyte solution is a liquid electrolyte. The electrolyte solution contains a solute and a solvent. The electrolyte solution may further contain an optional additive. The solute includes a supporting electrolyte. The solute may include, for example, at least one selected from the group consisting of LiPF₆, LiBF₄, LiN(SO₂F)₂, LiN(SO₂CF₃)₂, LiB(C₂O₄)₂, LiPO₂F₂, and FSO₃Li. The concentration of the solute may be, for example, 0.5 to 2.0 mol/L.

Referring to FIG. 2, as described above, a plurality of holes 180 are formed in the wound electrode assembly 100 (see FIG. 2). Each hole 180 extends in the radial direction (direction of R1 in the R direction) from the outer peripheral surface 150 of the wound electrode assembly 100 toward the winding axis Ax. In the present example, each hole 180 has a substantially cylindrical shape. However, the shape of each hole 180 is not limited to the cylindrical shape, and may be a rectangular shape or the like.

In the present example, each hole 180 extends to the vicinity of the winding axis Ax of the wound electrode assembly 100. Each hole 180 reaches the innermost layer of the wound electrode assembly 100. However, the present disclosure is not limited thereto, and each hole 180 may not necessarily reach the innermost layer of the wound electrode assembly 100. In this example, the axis Bx of each hole 180 is perpendicular to the winding axis Ax. However, the present disclosure is not limited thereto, and the axis Bx may be inclined downward (direction of Z2) as approaching the winding axis Ax, for example.

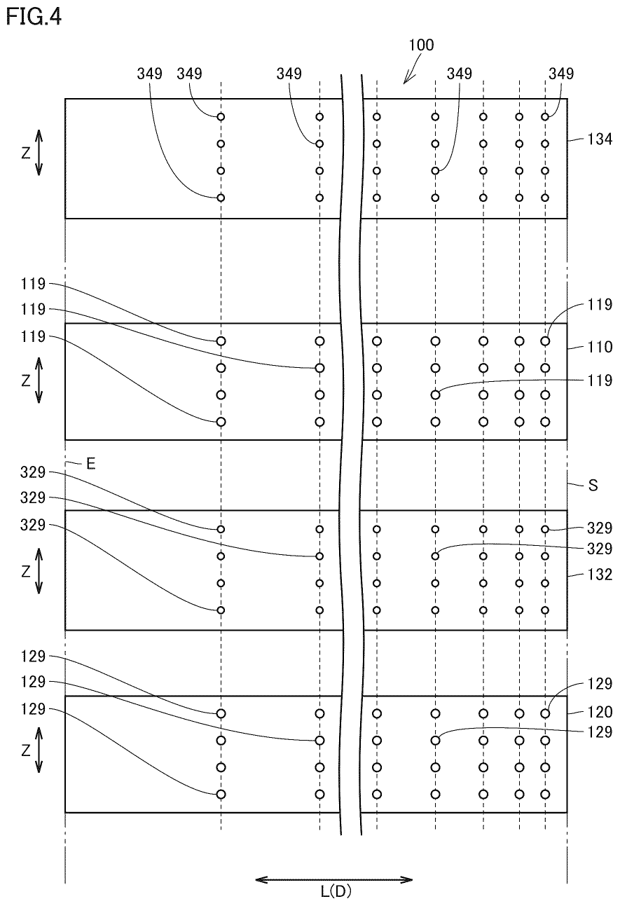

FIG. 4 is a diagram for explaining elements constituting the hole 180. Referring to FIG. 4, the wound electrode assembly 100 includes the negative electrode 120, the first separator 132, the positive electrode 110, and the second separator 134, as described above. The end S is the winding start side. The end E is the winding end side.

The holes 180 include a plurality of through holes 129 formed in the negative electrode 120, a plurality of through holes 119 formed in the positive electrode 110, a plurality of through holes 329 formed in the first separator 132, and a plurality of through holes 349 formed in the second separator 134.

In the direction of R2 shown in FIG. 2 (direction opposite to R1), the through hole 349, the through hole 119, the through hole 329, and the through hole 129 repeatedly overlap in this order to form one hole 180.

In other words, the through holes 349, 119, 329, 129 are formed in the negative electrode 120, the first separator 132, the positive electrode 110, and the second separator 134 so that the four through holes 349, 119, 329, 129 overlap with each other when the stack in which the negative electrode, the first separator, the positive electrode, and the second separator are stacked is spirally wound.

From the viewpoint of preventing short circuit between the negative electrode 120 and the positive electrode 110, in some embodiments, the opening areas of the through holes 329 and 349 of the first and second separators 132 and 134 are smaller than the opening area of the through hole 129 of the negative electrode 120 and the opening area of the through hole 119 of the positive electrode 110. Further, from the viewpoint of preventing the short circuit, in some embodiments, the opening area of the through hole 119 of the positive electrode 110 is larger than the opening area of the through hole 129 of the negative electrode 120. In some embodiments, among the through holes 119, 129, 329, 349, the opening area of the through hole 119 is the largest and the opening areas of the through holes 329 and 349 are the smallest. The present disclosure is not limited thereto, and the opening area of the through hole 129 may be larger than the opening area of the through hole 119.

Further, the sum of the opening areas at the opening ends 180a of the four holes 180 is larger than the opening area of the through hole 222 of the lid 202.

The through hole 119 is an example of the “positive electrode through hole” in the present disclosure. The through hole 129 is an example of the “negative electrode through hole” in the present disclosure. The through holes 329 and 349 are examples of the “separator through hole” in the present disclosure.

### <Aspects>

(1) As described above, as shown in FIG. 1, the power storage device 10 includes the wound electrode assembly 100 and the case 200 that contains an electrolyte solution and the wound electrode assembly 100. As shown in FIGS. 2 and 3, the wound electrode assembly 100 has the winding axis Ax extending in the Z direction, and is configured by spirally winding a stack including the strip-shaped positive electrode 110, the strip-shaped negative electrode 120, and the strip-shaped separator 130 around the winding axis Ax. The wound electrode assembly 100 has the outer peripheral surface 150 facing the case 200. The wound electrode assembly 100 is formed with the hole 180 extending in a direction (direction of R1) from the outer peripheral surface 150 toward the winding axis Ax.

According to such a configuration, the electrolyte solution can permeate into the wound electrode assembly 100 from the outer peripheral surface 150 side of the wound electrode assembly 100 through the hole 180. Therefore, according to the power storage device 10, the electrolyte solution is easily permeated (impregnated) into the wound electrode assembly 100 as compared with a configuration in which the hole 180 is not formed in the wound electrode assembly. Further, the hole 180 may serve as absorption margin when the wound electrode assembly 100 expands and shrinks.

(2) As shown in FIG. 4, the hole 180 includes a plurality of through holes 119 formed in the positive electrode 110, a plurality of through holes 129 formed in the negative electrode 120, and a plurality of through holes 329 and 349 formed in the separator 130. The opening area of each of the through holes 329 and 349 is smaller than the opening area of each of the through holes 129 and the opening area of each of the through holes 119.

According to such a configuration, as compared to the case where the opening areas of the through holes 329 and 349 are larger than the opening areas of the through holes 129 and 119, it is possible to reduce the possibility of short circuit between the positive electrode 110 and the negative electrode 120 through the through holes 329 and 349 formed in the separator 130.

(3) As shown in FIG. 4, the opening area of the through hole 119 is larger than the opening area of the through hole 129.

According to such a configuration, it is possible to further reduce the possibility that the positive electrode 110 and the negative electrode 120 are short-circuited through the through holes 329 and 349 formed in the separator 130, as compared with the case where the opening area of the through hole 119 and the opening area of the through hole 129 are the same.

(4) As shown in FIG. 1, the case 200 has the inner peripheral surface 211 facing the outer peripheral surface 150 of the wound electrode assembly 100. The groove 215 extending in the Z direction is formed in the inner peripheral surface 211. The groove 215 faces the hole 180.

According to such a configuration, it is possible to exchange the electrolyte solution and gas between the groove 215 and the hole 180. Specifically, the electrolyte solution can easily flow into the hole 180 through the groove 215. Further, the gas accumulated in the hole 180 can be guided to the groove 215. Therefore, the power storage device 10 is desirable in terms of injection of the electrolyte solution and discharge of the gas generated in the wound electrode assembly 100, as compared with the configuration not having the groove 215.

(5) As shown in FIG. 1, the case 200 includes the main body 201 having the upper end portion 213 and the groove 215 formed up to the upper end portion 213, and the lid 202 having the through hole 222 penetrating in the Z direction and attached to the main body 201 from above. The through hole 222 is located above the groove 215. The power storage device 10 further includes the cap 223 that closes the through hole 222.

According to such a configuration, since the through hole 222 is located above the groove 215, the electrolyte solution can be easily guided to the groove 215 by injecting the electrolyte solution from the through hole 222.

(6) As shown in FIGS. 1 and 2, a plurality of holes 180 are formed in the wound electrode assembly 100. Therefore, as compared to the case where there is one hole 180, liquid injection and gas discharge at the time of abnormality are desirable.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage device comprising:
a wound electrode assembly with a winding axis extending in a predetermined direction, the wound electrode assembly being formed of a stack wound spirally around the winding axis, the stack including a positive electrode in a strip shape, a negative electrode in a strip shape, and a separator in a strip shape; and
a case containing an electrolyte solution and the wound electrode assembly, wherein
the wound electrode assembly has an outer peripheral surface facing the case, and
a first hole extending in a direction from the outer peripheral surface toward the winding axis is formed in the wound electrode assembly.

2. The power storage device according to claim 1, wherein
the first hole includes a plurality of positive electrode through holes formed in the positive electrode, a plurality of negative electrode through holes formed in the negative electrode, and a plurality of separator through holes formed in the separator, and
an opening area of each of the separator through holes is smaller than an opening area of each of the negative electrode through holes and an opening area of each of the positive electrode through holes.

3. The power storage device according to claim 2, wherein the opening area of each of the positive electrode through holes is larger than the opening area of each of the negative electrode through holes.

4. The power storage device according to claim 1, wherein
the case has an inner peripheral surface facing the outer peripheral surface,
a groove extending in the predetermined direction is formed in the inner peripheral surface, and
the groove faces the first hole.

5. The power storage device according to claim 4, wherein
the case includes:
a main body having an upper end portion, with the groove extending to the upper end portion; and
a lid having a second hole formed to extend through the lid in the predetermined direction, the lid being attached to the main body from above,
the second hole is located above the groove, and
the power storage device further comprises a closing member that closes the second hole.
